(19) United States
(12) Patent Application Publication
(10) Pub. No.: US 2007/0140048 A1
(43) Pub. Date: Jun. 21, 2007

(54) Seal and drain for blenders

(76) Inventor: Mahmoud Ismail, Hong Kong Island (HK)

Correspondence Address: Lawrence J. Shurupoff;Sunbeam Products, Inc., 2381 Executive Center Drive, Boca Raton, FL, 33431, US

(21) Appl. No.: 11/584,481

(22) Filed: Oct. 19, 2006

Related U.S. Application Data
(60) Provisional application No. 60/750,971, filed on Dec. 16, 2005.

(51) Int. Cl. A47J 43/046

(52) U.S. Cl. 366/205

(57) ABSTRACT

A dynamic and static seal is formed by a close clearance fit between a rotary coupling and a static upstanding wall on a motor housing such as a base for an electric blender. The seal centrifugally ejects spilt liquid during operation towards a network of drainage holes which direct the liquid away to prevent it from leaking into the blender's base. A down-turned U-shaped lip rotates around both sides and the top edge of the upstanding wall so as to form a rotary labyrinth seal. The wall forms a static barrier to liquid when the blender is not rotating.

### RELATED APPLICATION

This application claims the benefit of pending U.S. Provisional application Ser. No. 60/750,971, filed Dec. 16, 2005, whose specification and drawings are incorporated herein by reference.

### FIELD OF THE INVENTION

The present invention relates to a system for preventing the leakage of spilt liquid into the base of a blending appliance.

More specifically, the invention relates to a liquid shedding seal for directing spilt liquid and a draining system which cooperates with the seal to prevent the collection of such spilt liquid and its leakage into the blender's base.

### BACKGROUND OF THE INVENTION

Rubber o-rings and elastomeric gaskets have been commonly used in rotary kitchen appliances such as electric blenders to prevent liquids that have inadvertently spilled from the appliance's processing container or blender jar from seeping into the bearings and electric motor components within the appliance's base.

One example of such a sealing arrangement is shown in U.S. Pat. No. 5,655,834. Although such elastomeric seals work well initially, they can harden or dry out over time, crack and then leak.

Attempts have been made to shield the bearing from liquid spilling or migrating into the base, such as by the liquid-shedding running seal of U.S. Pat. No. 3,540,234. However, such contact seals are prone to wear from friction and relaxation and are found to be eventually unreliable in preventing spilt liquid which has collected on the base from overflowing the seal and entering the base.

U.S. Pat. No. 3,593,215 depicts a non-contact liquid-shedding seal, however no means are provided or offered for draining liquid which has collected on the base and preventing it from overflowing the seal and entering the base through the gap between the seal and the base.

### SUMMARY OF THE INVENTION

The present invention avoids the drawbacks noted above by dynamically preventing spilt liquids from reaching the drive shaft bearings of a blender type appliance, and by statically preventing the collection of such spilt liquids on the base to thereby prevent their leakage into the base.

A blending appliance having an improved liquid shedding seal directs spilt liquid from the bearing and prevents its inadvertent leakage into the base.

The blending appliance includes a draining system cooperates with the liquid-shedding seal to prevent the collection of spilt liquid on the base and the subsequent inadvertent leakage of such into the base.

The improved liquid shedding seal is incorporated into the connector of the base that engages the agitator of the blender's removable liquid holding jar.

An improved liquid-shedding seal for centrifugally directing spilt liquid from the bearing area of a blending appliance dynamically prevents the inadvertent leakage of spilt liquid into the base. The seal is separated from the base by a labyrinth gap which avoids friction and wearing while allowing the seal to shield the bearing area.

A draining system cooperates with the liquid-shedding seal by receiving the spilt liquid from the seal and draining it off of the base to prevent its built-up to a level where it might otherwise leak through the labyrinth gap and into the base. The integration of the liquid-shedding seal and labyrinth gap into the connector of the base that engages the agitator of the blender's removable liquid holding jar provides superior sealing.

A rotating lip or flinger centrifugally hurls liquid away from the drive shaft bearings into a surrounding blender jar socket. Drain holes are formed through an annular hub which surrounds and supports the jar to define a jar socket. Liquid may then drain out of the jar socket through one or more of the drain holes to prevent its build-up within the socket and thereby prevent is eventual leakage into the base.

An annular collecting trough may surround the annular hub to prevent the liquid from flowing onto surrounding countertops or kitchen surfaces.

### BRIEF DESCRIPTION OF DRAWINGS

FIG. 1 is a perspective view of a base for an electric blender provided with a seal and drain arrangement in accordance with the present invention.

FIG. 2 is a partial schematic side view in section of the base of FIG. 1.

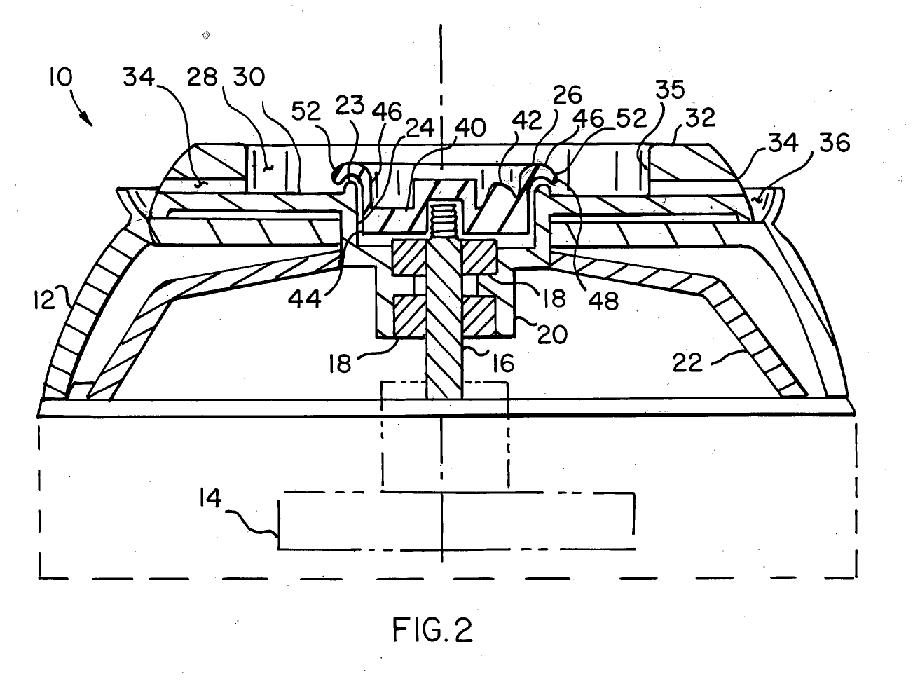

### DETAILED DESCRIPTION OF THE PREFERRED EMBODIMENT

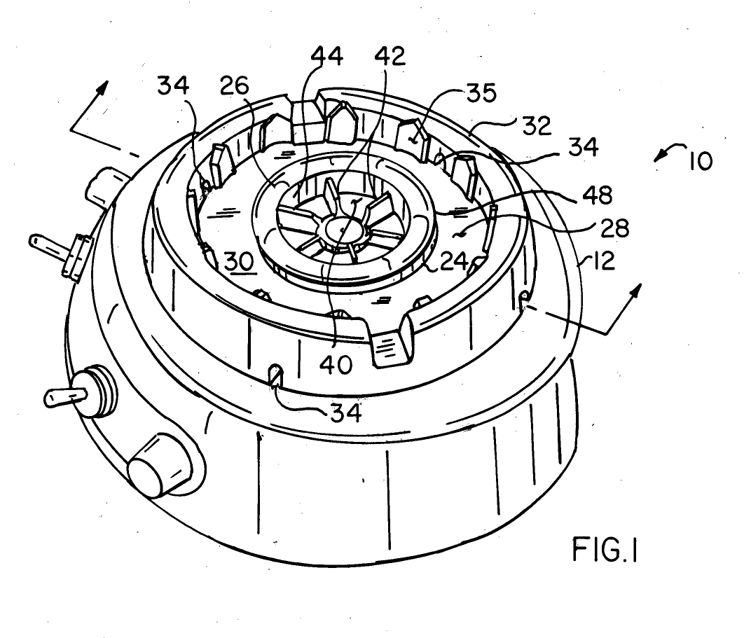

As seen in FIG. 1, a base 10 for a rotary electric appliance such as a drink mixer is provided with an outer wall or casing 12. An electric motor 14 is coupled to drive shaft 16 which is centered within and supported by one or more bearings 18.

The bearings 18 are mounted within a tubular bearing housing 20. An annular frame 22 centers and supports the bearing housing 20 within the casing 12. A first annular wall in the form of a collar 24 extends vertically upwardly from the bearing housing 20 and extends upwardly from an opening 26 in the roof of the casing 12.

An annular recess or socket 28 is defined by the annular wall 24, an annual floor 30 that extends radially outwardly below the top edge of the wall 24 and an outer annular hub 32 that extends upwardly from floor 30. Annular hub 32 comprises a second annular wall 35, surrounding collar 24 to define socket 28, which is adapted to receive the lower end of a blender jar or other food processing container (not shown) in a known fashion.

Annular floor 30 defines the effective top surface of casing 12 and cooperates with second annular wall 35 to support the container. Because annular hub 32 is continuous, it is sufficiently rigid to support the container even when filled with liquid, against the tangential forces of agitation and against unforeseen impacts and forces.

One or more liquid drains in the form of holes or channels 34 are formed through the wall 35 at the bottom of hub 32 and along and coplanar with floor 30. An annular trough 36 surrounds the hub 32 to retain any liquid drained from socket 28 through drain holes 34.

A coupler 40 in the form of a toothed gear, wheel or clutch is connected to the upper end of drive shaft 16. Circumferentially-spaced teeth 42 extend upwardly from coupler 40 in a known fashion to form a connecter for engaging a rotary tool of the container, such as the agitator blade of a blender.

The outer annual wall 44 of coupler 40 is nested within annular wall 24 with a very close clearance fit so as to form a lower portion of an annular labyrinth seal 46, which creates a liquid-shedding shield over hole 26 as the seal and coupler are rotated. Coupler 40 can be formed of hard plastic or elastomeric material, or from metal.

The upper portion of labyrinth seal 46 is formed by a very close clearance fit between the upper rim 23 of annular wall 24 extending above floor 30 and a down-turned or inverted U-shaped annular lip 48. Lip 48 can be formed homogeneously with clutch 40 as a vertical extension of wall 44, such as by plastic molding, or mounted to clutch 40 as a separate ring-shaped member. A tortuous inverted J-shaped clearance path 52 is defined between wall 24 and lip 48.

When the blender is in operation, a blender jar is inserted within socket 28 and a clutch or toothed gear on the jar engages the coupler 40 and clutch teeth 42 to form a rotary coupling. When the motor 14 is activated, drive shaft 16 rotates within bearings 18 and drives the clutch 40 which in turn drives a rotary tool connected to the clutch in the blender jar.

As clutch 40 rotates, lip 48 spins around and over static wall 24 and centrifugally hurls any liquid collecting in socket 28 radially outwardly and through drain channels 34, and into trough 36. This prevents liquid from entering the bearing housing 20 and harming the bearings 18, drive shaft 16 and motor 14.

Because drains 34 lie on surface 30 and below rim 23, liquid cannot accumulate within socket 28 to a level high enough to overflow into hole 28, and can there-fore not leak into casing 12 through bearings 18. This sealing and draining arrangement thereby functions in both a dynamic fashion, shedding inadvertently spilt liquid away from bearings 18 as the appliance is operating, and a static fashion, draining such liquid away before it can accumulate to a damaging level.

It can be appreciated that the sealing and draining arrangement provides a structure and method to prevent water and other liquids from accessing the bearing area of the lower clutch mechanism of any product that is motor driven and uses a clutch coupling to engage a jar, typically formed of plastic or glass. Normal usage of such products results in liquid accumulated in the bottom area of the unit around the coupling.

Prior attempts to keep the water away from the bearing area and from leaking inside the unit have been focused on sealing the shaft bearings. Liquid still accumulated and posed a risk of corrosion to the bearing and the possibility of leaking inside the lower compartment.

The sealing and draining arrangement provides a design that prevents the liquid from ever accessing the interface area between rotating and static parts. It includes adding a cover or lip to the interface area using the coupler itself. The liquid either accumulates inside the coupler area or around it. An overflow slot in the form of drain 34 is provided on the outside perimeter of the base to drain the liquid outside the unit before it rises and overflows wall 24 separating the housing from the bearing area.

The sealing and draining arrangement provides a very inexpensive method of sealing the bearing and motor area without the need for tight seals or expensive bearing materials.

I claim:

1. In a kitchen appliance having a base and a rotary tool removable there-from, a seal and drain system comprising:
a casing surrounding the base and comprising:
a top surface;
a clearance hole formed through said top surface;
a first upstanding annular wall surrounding said clearance hole and having a first height above said top surface and;
a second upstanding annular wall surrounding said first upstanding annular wall and having a second height above said top surface greater than said first height, said second upstanding annular wall configured to surround and support the removable rotary tool;
one or more drains formed through said second annular wall along said top surface below said first height and;
a motor mounted within said casing;
a drive shaft coupled to said motor and projecting upwardly through said hole and coaxial with said first upstanding annular wall;
a coupler driven by said drive shaft for driving the rotary tool; and
a rotatable seal member covering said first upstanding annular wall and driven by said coupler and adapted to direct liquid spilt thereon away from said hole and towards and through said one or more drains.

2. The seal and drain system of claim 1 wherein said first annular wall, said rotatable seal, and said one or more drains cooperate to define a static and dynamic seal and drain system for preventing said spilt liquid from inadvertently leaking into said casing.

3. The seal and drain system of claim 2, further comprising an annular lip on said rotating seal member closing overhanging said first annular wall.

4. The seal and drain system of claim 3, wherein said rotatable seal member comprises an inverted U-shaped lip.

5. The seal and drain system of claim 3, wherein said rotatable seal member and said first annular wall define an inverted J-shaped clearance path.

6. A blending appliance comprising:
a container for holding liquid and having a rotatable mixing blade associated there-with for agitating said liquid;
a base comprising a housing containing an electric motor and having a generally horizontal upper surface;
said upper surface comprising a hole there-through and a cylindrical collar projecting vertically upwardly there-from around said hole and towards said container, said collar comprising a circular upper rim;
said motor comprising a rotatable motor shaft extending vertically upwardly through said hole and within said collar and concentric with said collar;
a coupler affixed to an upper terminal end of said motor shaft and rotatable therewith and adapted to rotationally engage said mixing blade such that rotation of said motor causes rotation of said blade and agitation of said liquid;
a rotational shield affixed to said upper terminal end of said motor shaft and rotatable therewith and comprising:
a disc portion extending radially outwardly beyond said circular upper rim and spaced there-above, and
an annular skirt portion extending downwardly around and to below said circular rim and spaced axially outwardly there-from,
said rotational shield being thereby adapted to rotationally encapsulate said rim and retard inadvertent leakage of liquid into said housing through said collar;
and wherein said housing further comprises an upstanding annular wall surrounding said collar and adapted to receive and support said container on said horizontal upper surface and;
said upstanding annular wall comprises one or more drains there-through, coplanar with said horizontal upper surface.

7. The blending appliance of claim 6 wherein said shield further comprises said coupler.

8. The blending appliance of claim 7 wherein said shield is integrally formed with said coupler.

9. The blending appliance of claim 8 wherein said shield is integrally formed with said coupler by plastic molding.

10. The blending appliance of claim 6 wherein said collar, shield and one or more drains cooperate to define a static and dynamic leakage prevention means for retarding inadvertent leakage of liquid into said housing through said collar.

11. The blending appliance of claim 10 wherein said coupler extends radially outwardly from said upper terminal end of said motor shaft to said disk portion and; said shield comprises a circular groove concentric with said collar and adapted to receiving and rotationally encapsulate said rim to further retard inadvertent leakage of liquid into said housing through said collar.

12. In a blending appliance having a motor housing with a rotatable motor shaft extending outwardly through a hole in a surface of the housing, the motor shaft affixed to a rotational connector adapted to engage the agitation blade of a removable container, and an outwardly projecting annular wall for receiving and supporting the removable container, the improvement comprising a seal and drain arrangement for retarding the inadvertent leakage of liquid into the housing, said seal and drain arrangement comprising a collar, a shield, and one or more drains;
said collar comprising a cylinder integral with the housing and extending outwardly from the surface, said collar concentric with the motor shaft and having a planar circular rim perpendicular to the motor shaft;
said shield rotatably affixed to the connector and the motor shaft and comprising a circular wall concentric with the motor shaft and extending radially from the motor shaft beyond said collar, and spaced axially from said planar circular rim;
said shield further comprising an outer cylindrical skirt concentric with the motor shaft and spaced radially outwardly from said collar and projecting inwardly from said circular wall towards the housing to beyond said planar circular rim to thereby retard the inadvertent leakage of liquid into the housing through the collar, and;
said one or more drains comprising holes along the surface and through the outwardly projecting annular wall.

13. The improvement of claim 12 wherein said shield, collar and one or more drains cooperate to define a static and dynamic leakage prevention arrangement and retard the inadvertent leakage of liquid into the housing through the collar.

14. The improvement of claim 13 wherein said shield is integrally formed with the connector.

15. The improvement of claim 14 wherein said shield is integrally formed with the connector by plastic molding.

16. The improvement of claim 12 wherein said shield is integrally formed with the connector.

17. The improvement of claim 16 wherein said shield is integrally formed with the connector by plastic molding.

18. A blender base, comprising:
a housing having a top wall with a central passage formed there through;
an annular wall surrounding said central passage;
a drive shaft extending through said central passage;
a disc mounted to said shaft and having a lip curled over and spaced apart from said annular wall thereby forming a tortuous clearance path between said disc and said annular wall; and
a drain for draining liquid radially outwardly from said annular wall.
